(19) United States
(12) Patent Application Publication
(10) Pub. No.: US 2002/0082969 A1
(43) Pub. Date: Jun. 27, 2002

(54) Event ticket pricing and distribution system

(76) Inventors: Gerard M. O'Keeffe, Killiney (IE); W. Denis O'Reilly, Glenageary (IE)

Correspondence Address: Robert F. I. Conte, LEE, MANN, SMITH, McWILLIAMS,, SWEENEY & OHLSON, P.O. Box 2786, Chicago, IL, 60690-2786, US

(21) Appl. No.: 09/742,592

(22) Filed: Dec. 21, 2000

(51) Int. Cl. G06F 17/60

(52) U.S. Cl. 705/37; 705/5

(57) ABSTRACT

A method for event ticket distribution comprises the steps of distributing event tickets allocated to a first distribution pool in accordance with a decreasing selling price auction distribution, and, upon completion of the auction distribution, distributing event tickets allocated to at least a second distribution pool. The event tickets allocated to at least a second distribution pool may be distributed in accordance with a lottery distribution.

### FIELD OF THE INVENTION

This invention relates generally to event ticket pricing and distribution systems and in particular to a ticketing process that maximizes return for event promoters by enabling sales revenues to reach true market value while minimizing distribution system inequities.

### BACKGROUND OF THE INVENTION

The presentation of live concerts, sporting events, and other forms of entertainment, particularly in large venues, is an enormous business enterprise that generates billions of dollars each year for promoters, sports teams, athletes, performers, venues, and ticketing companies. However, a significant portion of the total revenue generated by this kind of entertainment enterprise (particularly those “premium events” where demand exceeds supply) does not go to the parties who have created the event; that is, to the promoters, owners, performers and investors. This value is instead captured by the secondary and black markets, comprised of ticket brokers, scalpers and touts, who profit from the deficiencies in the event ticketing process.

This is a widely acknowledged problem, within and outside the industry. However, attempts to remedy or even significantly improve the position for the industry have not met with much success for a variety of reasons. In fact, despite technological advances and various other periodic initiatives by the industry and regulatory bodies, the fundamental methodologies for event ticket pricing and distribution have not been significantly improved upon for many years. As a result, it continues to be acknowledged that a major deficiency in the event ticketing process results in a significant part of the economic value in premium event tickets being lost by the industry to the secondary market.

Furthermore, in addition to the obvious economic impact to the industry participants and investors, the deficiencies in the event ticketing process are also significantly to the detriment of the interests of consumers who wish to buy these tickets, as well as to governmental and revenue agencies.

Attempts by the industry to prevent this diversion of the value that it has created, to others who take advantage of the excess demand in the system, are frustrated by the practical and logistical issues particular to this industry.

These practical and logistical issues also beget many other significant deficiencies in the event ticketing process. It is widely acknowledged that the existing ticket distribution system in particular is fundamentally inequitable and sustains a variety of practices which range from being simply inconvenient for consumers to being deceptive and quite often unlawful. There are plentiful examples of reports by the industry and by regulatory agencies calling for the development of a better practical alternative. While ticket selling has now begun to grow on-line via the Internet, it seems there has been no significantly successful development in the fundamental process, specifically the key pricing and distribution methodologies, to make an impact in the reduction of these major industry process deficiencies. In fact, the emergence of the Internet has exacerbated many of the problems.

Most of these problems (not just for the industry, but also for the consumer and for regulatory and revenue agencies) are directly linked to the existence and operation of the secondary/black market of ticket brokers and touts. However, these markets themselves owe their prosperity to the existing standard methods of ticket pricing and distribution that, in combination, appear to be the best way yet found by the industry to ensure its practical efficiency. This remains the case, despite the widely acknowledged requirement for a better system that comprehends the complicated and time-sensitive correlation among supply, demand and pricing of tickets, together with the logistical practicalities and equity of ticket-distribution, particularly to the mass market.

If the black/secondary market were to be eliminated by ensuring that the full market value of each ticket were captured by the primary distributor within the industry (generally the event promoter), it would obviously be to the benefit of the industry in general. However, it would also be to the benefit of the ticket-buying public if there were a more transparent market, free from the supply and pricing manipulation that currently exists. It would also be beneficial for the quality of the event product if its full value/return were received by its investors. Finally, it is in the acknowledged interests of governmental bodies to have a more equitable system, not least because of the likelihood of garnering additional taxation revenue, which is generally not collected from the black market.

The bottom line is that some consumers (often wealthy individuals and corporate businesses) are already paying the inflated prices for the tickets, but current practices do not allow this value to be captured within the industry.

The elements of the ticketing process responsible for allowing the secondary/black markets to exist are primarily the pricing and distribution practices.

In terms of pricing, ideally, a promoter would wish to match individual ticket prices with actual market demand for those tickets. However, practical constraints to allow rapid and diverse “mass market” selling dictate that ticket prices are generally based on a “block-pricing” strategy. Large blocks of seats are assigned the same “face value” price, notwithstanding the fact that there are inevitably different values attributable to various seats within that “block.” These prices are predetermined and inflexible, thus allowing for considerable gaps between standard prices determined and charged by the industry and prices which the market will bear/pay.

Standard distribution practices, irrespective of the channel of distribution, are based largely on a “first come, first served” basis. This results in a queuing system either physically (at ticket booths), on phone lines, and most recently on-line via the Internet. This distribution system is generally inconvenient and unfair to ordinary consumers. If one wishes to obtain an “in-demand” ticket, there is a very narrow window of opportunity in which to get it. This system is biased against those who do not find it convenient to be at a queuing location at a particular time, or do not have the ability or patience to engage in telephone queuing.

It is generally perceived that trying to obtain a ticket that is much in demand through one of these queuing systems is often an exercise in futility. This perception has been confirmed by, among others, a report to the New Jersey governor on Access to Entertainment in New Jersey (their research indicates that up to 90% of “in-demand”tickets are not available directly to the public, but are siphoned off into the secondary market). This futility is due to the efforts (sophisticated and otherwise) employed by the black/secondary market brokers/touts to obtain a major portion of tickets sold in these ways. These methods include sophisticated telephone equipment to maximise telephone/Internet queue results, manning the physical queues at ticket booth locations with employees, and “under the counter” deals with ticketing company employees.

Having secured their supply, these touts and brokers can manipulate the market to extract maximum value for each ticket, using lack of transparency on price and availability, as well as outright deception, to make large profits. Given their ability to ensure supply (using whatever means deemed necessary), these brokers and touts build up considerable loyalty from their “clients,” particularly wealthy individuals and corporations. The repercussions of these illicit practices are so widely felt that the New York Attorney General's office recently conducted a detailed analysis and report on the industry, an excerpt of which follows:

“The process by which tickets wend their way from the original issuer to the ultimate consumer is complex and often illegal . . . The Attorney General's investigation demonstrates that ticket distribution practices are seriously skewed away from ordinary fans and toward wealthy business and consumers. This problem is not simply the result of the law of supply and demand. Rather, the availability of tickets and the outrageously high prices that brokers charge to a large extent can be laid at the door of illicit practices in the ticket industry and other practices that . . . are deceptive, unfair to the ticket buying public, and supportive of the corrupt ticket distribution system. The price that tickets to popular events command in the marketplace belongs to the performers, producers and investors who create the events, not the speculators who through illegality and deception take advantage of the excess demand in the system. Ticket scalping is sometimes referred to as a victimless crime. To the contrary, the victims of the current ticket distribution system are the fans, the producers, and the investors who create the events and the State of New York, which loses both tax revenues and credibility as the entertainment center of the world.

If there is excess demand in the system which results in excess profits, these profits should not, in fairness, become a windfall for people who add no value to the product represented by the ticket. The people who should be participating in such gains are the creative people who produce the product and the investors or risk takers who finance it.”

Past attempts at addressing these widely acknowledged industry problems have not succeeded to any significant degree as variations of either pricing or distribution practices have simply resulted in exacerbating existing problem issues or creating new practical problems. The arrival of the Internet has led to renewed efforts to develop auctioning systems in this area in an attempt to ensure that the promoter could accurately bid up the ticket price for each individual ticket to the real market price. By definition, if the promoter can obtain maximum market value for the tickets, then there is no additional value in those tickets to sustain the existence of a black market. The secondary market would then simply be relegated to an exchange market for last minute tickets, which would not sustain the supply and pricing manipulation to the degree that leads to the large scale industry deficiencies.

However, despite some technological advances in real time auctioning systems on the Internet, auctioning of tickets still retains the time (if not location) sensitivity which is a major factor in preventing a genuine market value being reached from all interested parties. This restriction of bidders allows the secondary market to retain its ability to manipulate the supply and pricing. In addition, it is commonly acknowledged that real time “mass market” auctioning of a large quantity of individual items is not yet technologically practical, reliable, or fair.

It is evident from the lack of industry acceptance that auction systems alone fail to solve the problems of the industry. In fact, it is the secondary market that makes use of auctions successfully to sell small numbers of individual tickets, not being restrained by the requirements of mass market selling and distribution. This follows the pattern of auction sites generally which are successful in selling individual items.

Efforts by the industry to radically raise the prices of all tickets have resulted in negative publicity, alienating “real fans” from events, something which is not in the interest of the industry in general. A theoretical matching of supply and demand simply on a “highest bid” basis (ignoring the practical issues) results in a similar situation where real fans are excluded to the benefit of wealthy consumers and corporations.

Accordingly, a need arises for an event ticketing process that maximizes return for event promoters by enabling sales revenues to reach true market value, and then ensuring that this value finds its way to the event promoters. However, this new process would only be successful if it addresses not just pricing, but also the distribution system inequities that sustain the secondary market and takes account of the complicated and time-sensitive correlation between the supply, demand and pricing of tickets, together with the logistical practicalities and equity of event ticket-distribution.

### SUMMARY OF THE INVENTION

These needs and others are addressed by the present invention, which provides a system and method whereby event promoters sell a certain proportion of all tickets for a particular event at the highest price per ticket the market will bear, thus substantially redirecting revenue from the existing secondary/black market to the industry parties who have created the event. Furthermore, a system and method is provided whereby event promoters may sell a further portion of all tickets for a particular event by means of a form of lottery that is fair and transparent, and is not based on a “first come first served” premise, thus ensuring equitable distribution of tickets to the detriment of the secondary/black market, and to the benefit and convenience of ticket-buying consumers.

The inventive ticket pricing and distribution system for large events, as described herein, is directed toward eliminating or minimizing known problems with such ticket distribution: namely that (1) much of the value of the ticket sale venture is diverted to touts and scalpers, (2) the fact that current distribution practices sustain the ability of the secondary/black markets to manipulate supply and demand for profit, and (3) the fact that existing distribution processes and practices are inequitable and inconvenient for the consumer, and result in the substantial restriction of access to tickets that are in demand.

The resolution of the problems associated with this industry requires both the redirection of ticket premium revenues from the black/secondary markets to the industry and the reduction/elimination of the ticket distribution system inequities, which further sustain the black/secondary markets.

Thus, the present invention provides event promoters with the ability to redirect vast sums of money from the black/secondary markets to within the industry by ensuring that maximum value for event tickets is extracted by the primary and authorized ticket distributors. By virtue of this, the value currently associated with black market ticketing will be substantially reduced.

Furthermore, the present invention provides for a fair and transparent allocation of tickets for mass market events in a practical manner (without absolute time and location sensitivities), thus substantially eliminating the current supply sources for the black/secondary market.

In addition to the obvious economic advantages to the industry of significantly recapturing the value in premium tickets from the black/secondary markets, this invention also provides very significant benefits to all ticket-buying consumers. These advantages flow from the absence of supply and pricing manipulation by speculative parties and the fairness and convenience provided by the reduction and elimination of time and location bias in ticket distribution.

Governmental agencies will benefit from the likelihood of garnering additional taxation revenue, which is generally not collected from the black market. A fairer and more transparent event ticketing process is the stated aspiration of regulatory bodies, as exemplified by the New York Attorney General.

In the system contemplated by the present invention, recognized and deserving charities may benefit from a process designed principally to eliminate the black market and to ensure full value is delivered to both industry players and the event-going public alike.

It is the unique attribute of this invention, in its systematic combination of both pricing and distribution solutions, that all of the above parties benefit substantially without diluting the primary economic benefit to the event promoters.

The inventive system helps ensure that ticket revenues wind up in the hands of the event promoters, where the value is supposed to go. As discussed above, the effect of the Internet thus far has largely been to undermine this desired value distribution. Many Internet sites are virtual scalpers, selling event tickets at many times the face value and pocketing the profits.

The system in accordance with the present invention restores proper value distribution by combining a decreasing selling price auction with a secondary distribution occurring after the auction distribution is completed. A first portion of the available tickets are placed into the auction pool, where the initial size of the auction pool is determined, at least in part, by the ticket price, the event venue, the size of the applicable market, and anticipated demand. The remaining tickets are placed into one or more secondary distribution pools. The process is optimized if the only way for a consumer to be certain of obtaining a ticket is to purchase at market value via the auction. Once the auction is completed, the only alternative should be to participate in the transparent lottery process of the second distribution pool for the chance of obtaining a ticket at a low fixed price.

The initial auction pricing is deliberately set at an unsustainably high level, and scheduled for reduction at regular intervals. To facilitate bidding at this decreasing selling price auction, participants are encouraged to register over the ticket distribution web site or by telephone. This registration process may include providing payment details and agreeing to certain contractual provisions, for example, in return for which the participant receives a bidding reference number.

The web site also includes a notice that after the auction is completed, the secondary pool tickets will be distributed. This secondary distribution may be conducted in the form of a lottery, for example, at a predetermined low price. In order to participate in the lottery distribution, prospective participants may be asked to register over the web site or by telephone, and to pay the ticket lottery subscription fee in advance. The lottery subscription price may be very low, in the vicinity of $1 or $2 (or maybe $5, depending upon factors such as the performer, venue, target market, etc.). It should be noted that the lottery subscription price is very low indeed, when compared with the usual face value of concert tickets ($25 to $50, for example). For a 5,000 ticket lottery pool, the promoter may collect $50,000 (1 dollar each from 50,000 eager, would-be attendees, for instance). Preferably, the secondary pool tickets are distributed to registered lottery purchasers selected at random, or through a predetermined distribution algorithm designed to result in fairness. The primary purpose of the lottery subscription is not promoter profit, but specifically to eliminate market manipulation by brokers through multiple entries.

Lottery subscribers may be asked to provide their payment details just as auction participants are, so that lottery winners may be billed for the face value of the tickets they have requested. Of course, the number of tickets permitted for each lottery subscriber may be limited (each lottery subscriber may be limited to 4 or 8 tickets, for example).

By using a portal site for both the auction and secondary distributions, the promoter subjects participants to ancillary advertising and promotion of the kind generally associated with portal sites. This system provides a more realistic opportunity for the purchasing public to investigate ticket buying opportunities, which should have the effect of increasing the size of the market.

Many of the operative parameters associated with this method are preferably controlled by statistical analysis (somewhat empirical and adaptive in some cases) of transactions occurring on the web site. Responses in the auction phase are analyzed to decide how much to reduce the asking price for example, and whether to alter the size of the secondary distribution pool (or pools). In fact, respective sizes of the secondary distribution pools may be decided dynamically through transaction analysis. Of course, some parameters, such as the initial auction pool size, initial auction price, and initial first pool lottery subscription price, are preferably established in advance, but may be susceptible of calculation through adaptation of known marketing formulae. The model provides data gathering capabilities that allow the transaction model to be optimized and even altered if desired.

In accordance with one aspect of the invention, a method for event ticket distribution comprises the steps of distributing event tickets allocated to a first distribution pool in accordance with a decreasing selling price auction distribution, and, upon completion of the auction distribution, distributing event tickets allocated to at least a second distribution pool.

The step of distributing event tickets in accordance with a decreasing selling price auction distribution may further include the steps of determining an initial size for the first distribution pool, establishing an initial selling price for the event tickets in the first distribution pool, and determining a price decrement amount for the decreasing selling price auction.

In another aspect of the invention, the step of distributing event tickets in accordance with a decreasing selling price auction distribution further includes, during the auction distribution, the steps of collecting and recording transaction information related to the decreasing selling price auction distribution, dynamically determining selling price decrement amount based, at least in part, upon the transaction information, and dynamically determining relative sizes of the first and second distribution pools based, at least in part, upon the transaction information. The method may further include dynamically determining a termination time for the step of distributing event tickets in accordance with it decreasing selling price auction distribution based, at least in part, upon the transaction information.

In another form of the invention, distributing event tickets allocated to at least a second distribution pool may comprise distributing the event tickets in accordance with a lottery distribution. The lottery distribution may further comprise the steps of collecting and recording lottery participant information, collecting and recording ticket request information, including number of tickets requested by each lottery participant, and identifying participants to whom tickets are distributed.

In accordance with a further aspect of the invention, identifying participants to whom tickets are distributed includes a random selection process weighted in accordance with predetermined weighting criteria. The predetermined weighting criteria may include geographic location, association membership, and participation history. The selection process may be weighted such that probability of selection for a participant decreases with increasing number of tickets selected by the participant. Collecting and recording lottery participant information may include charging each lottery participant a predetermined subscription fee, and event tickets remaining in the first distribution pool may be reallocated to the second distribution pool at termination time.

In yet another form of the invention, a method for event ticket distribution comprises the steps of allocating event tickets to at least first and second distribution pools, collecting and recording participant information, distributing event tickets allocated to the first distribution pool in accordance with a decreasing selling price auction distribution, and, during the distribution, collecting and recording transaction information related to the decreasing selling price auction distribution. The method further includes dynamically determining selling price decrement amount based, at least in part, upon the transaction information, dynamically determining relative sizes of the at least first and second distribution pools based, at least in part, upon the transaction information, and, upon completion of the decreasing selling price auction distribution, distributing event tickets allocated to at least the second distribution pool.

In still a further aspect of the invention, the method may further include dynamically determining a termination time for the step of distributing event tickets in accordance with a decreasing selling price auction distribution based, at least in part, upon the transaction information.

In accordance with yet another form of the invention, the step of distributing event tickets allocated to at least a second distribution pool comprises distributing the event tickets in accordance with a lottery distribution. Distributing the event tickets in accordance with a lottery distribution may further comprise the steps of collecting and recording lottery participant information, collecting and recording ticket request information, including number of tickets requested by each lottery participant, and identifying participants to whom tickets are distributed. Identifying participants to whom tickets are distributed may include a random selection process weighted in accordance with predetermined weighting criteria. The predetermined weighting criteria may include geographic location, association membership, and participation history. The selection process may be weighted such that probability of selection for a participant decreases with increasing number of tickets selected by the participant. Collecting and recording lottery participant information may include charging each lottery participant a predetermined subscription fee, and event tickets remaining in the first distribution pool may be reallocated to the second distribution pool at termination time.

In still another form of the invention, a method for event ticket pricing and distribution comprises the steps of allocating event tickets to at least first and second distribution pools, collecting and recording participant information, distributing event tickets allocated to the first distribution pool in accordance with a decreasing selling price auction distribution, and, during the distribution, collecting and recording transaction information related to the decreasing selling price auction distribution, dynamically determining selling price decrement amount based, at least in part, upon the transaction information, dynamically determining relative sizes of the at least first and second distribution pools based, at least in part, upon the transaction information, and dynamically determining a termination time for the step of distributing event tickets in accordance with a decreasing selling price auction distributior based, at least in part, upon the transaction information. In this form of the invention, at a predetermined time, the method also includes distributing event tickets allocated to at least the second distribution pool in accordance with a lottery distribution that includes the steps of collecting and recording lottery participant information, collecting and recording ticket request information, including number of tickets requested by each lottery participant, and identifying participants to whom tickets are distributed.

In still a further form of the invention, identifying participants to whom tickets are distributed includes using a random selection process weighted in accordance with predetermined weighting criteria. The predetermined weighting criteria may include geographic location, association membership, and participation history. The selection process may be weighted such that probability of selection for a participant decreases with increasing number of tickets selected by the participant. Collecting and recording lottery participant information may include the step of charging each lottery participant a predetermined subscription fee, and event tickets remaining in the first distribution pool may be reallocated to the second distribution pool at termination time.

In accordance with another form of the invention, a system for event ticket distribution comprises means for distributing event tickets allocated to a first distribution pool in accordance with a decreasing selling price auction distribution, and means for distributing event tickets allocated to at least a second distribution pool upon completion of the auction distribution;

The means for distributing event tickets in accordance with a decreasing selling price auction distribution may further comprise means for determining an initial size for the first distribution pool, means for establishing an initial selling price for the event tickets in the first distribution pool, and means for determining a price decrement amount for the decreasing selling price auction. The means for distributing event tickets in accordance with a decreasing selling price auction distribution may further comprise means for collecting and recording transaction information related to the decreasing selling price auction distribution during the distribution, means for dynamically determining selling price decrement amount based, at least in part, upon the transaction information, and means for dynamically determining relative sizes of the at least first and second distribution pools based, at least in part, upon the transaction information.

The system may further include means for dynamically determining a termination time for the decreasing selling price auction distribution based, at least in part, upon the transaction information. The means for distributing event tickets allocated to at least a second distribution pool may comprise means for distributing the event tickets in accordance with a lottery distribution.

In yet another aspect of the invention, the means for distributing the event tickets in accordance with a lottery distribution further comprises means for collecting and recording lottery participant information, means for collecting and recording ticket request information, including number of tickets requested by each lottery participant, and means for identifying participants to whom tickets are distributed. The means for identifying participants to whom tickets are distributed may comprise a random selection process weighted in accordance with predetermined weighting criteria. The predetermined weighting criteria may include geographic location, association membership, and participation history. The selection process may be weighted such that probability of selection for a participant decreases with increasing number of tickets selected by the participant. The means for collecting and recording lottery participant information may include means for charging each lottery participant a predetermined subscription fee, and event tickets remaining in the first distribution pool may be reallocated to the second distribution pool at the termination time.

In accordance with yet a further aspect of the invention, a system for event ticket distribution comprises means for allocating event tickets to at least first and second distribution pools, means for collecting and recording participant information, means for distributing event tickets allocated to the first distribution pool in accordance with a decreasing selling price auction distribution, means for collecting and recording transaction information related to the decreasing selling price auction distribution during the distribution, means for dynamically determining selling price decrement amount based, at least in part, upon the transaction information, means for dynamically determining relative sizes of the at least first and second distribution pools based, at least in part, upon the transaction information, and means for distributing event tickets allocated to at least the second distribution pool upon completion of the auction distribution.

In another form of the invention, the system may further comprise means for dynamically determining a termination time for the decreasing selling price auction distribution based, at least in part, upon the transaction information. The means for distributing event tickets allocated to at least a second distribution pool may comprise means for distributing the event tickets in accordance with a lottery distribution.

In yet another aspect of the invention, the means for distributing the event tickets in accordance with a lottery distribution further comprises means for collecting and recording lottery participant information, means for collecting and recording ticket request information, including number of tickets requested by each lottery participant, and means for identifying participants to whom tickets are distributed. The means for identifying participants to whom tickets are distributed may comprise a random selection process weighted in accordance with predetermined weighting criteria. The predetermined weighting criteria may include geographic location, association membership, and participation history. The selection process may be weighted such that probability of selection for a participant decreases with increasing number of tickets selected by the participant. The means for collecting and recording lottery participant information may further include means for charging each lottery participant a predetermined subscription fee, and event tickets remaining in the first distribution pool may be reallocated to the second distribution pool at the termination time.

In still a further form of the invention, a system for event ticket pricing and distribution comprises means for allocating event tickets to at least first and second distribution pools, means for collecting and recording participant information, means for distributing event tickets allocated to the first distribution pool in accordance with a decreasing selling price auction distribution, means for collecting and recording transaction information related to the decreasing selling price auction distribution during the distribution, means for dynamically determining selling price decrement amount based, at least in part, upon the transaction information, means for dynamically determining relative sizes of the at least first and second distribution pools based, at least in part, upon the transaction information, means for dynamically determining a termination time for the decreasing selling price auction distribution based, at least in part, upon the transaction information, means for distributing event tickets allocated to at least the second distribution pool in accordance with a lottery distribution at a predetermined time, means for collecting and recording lottery participant information, means for collecting and recording ticket request information, including number of tickets requested by each lottery participant, and means for identifying participants to whom tickets are distributed.

The means for identifying participants to whom tickets are distributed may comprise a random selection process weighted in accordance with predetermined weighting criteria. The predetermined weighting criteria may include geographic location, association membership, and participation history. The selection process may be weighted such that probability of selection for a participant decreases with increasing number of tickets selected by the participant. The means for collecting and recording lottery participant information may include means for charging each lottery participant a predetermined subscription fee, and event tickets remaining in the first distribution pool may be reallocated to the second distribution pool at the termination time.

In accordance with still another form of the invention, a system for event ticket distribution comprises a memory device storing a program, a processor in communication with the memory, the processor operative with the program to allocate event tickets to at least first and second distribution pools, collect and record participant information, distribute event tickets allocated to the first distribution pool in accordance with a decreasing selling price auction distribution, collect and record transaction information related to the decreasing selling price auction distribution during the distribution, dynamically determine selling price decrement amount based, at least in part, upon the transaction information, dynamically determine relative sizes of the at least first and second distribution pools based, at least in part, upon the transaction information, and distribute event tickets allocated to at least the second distribution pool upon completion of the auction distribution.

In one form of the invention, the processor is operative to dynamically determine a termination time for the decreasing selling price auction distribution based, at least in part, upon the transaction information. The processor may be operative to distribute event tickets allocated to the at least a second distribution pool in accordance with a lottery distribution.

In accordance with still a further form of the invention, the processor is further operative to collect and record lottery participant information, collect and record ticket request information, including number of tickets requested by each lottery participant, and identify participants to whom tickets are distributed. The processor may be operative to identify participants to whom tickets are distributed using a random selection process weighted in accordance with predetermined weighting criteria. The predetermined weighting criteria may include geographic location, association membership, and participation history. The selection process may be weighted such that probability of selection for a participant decreases with increasing number of tickets selected by the participant. The processor may be operative to charge each lottery participant a predetermined subscription fee, and to reallocate event tickets remaining in the first distribution pool to the second distribution pool at the termination time.

Further objects, features, and advantages of the present invention will become apparent from the following description and drawings.

### BRIEF DESCRIPTION OF THE DRAWINGS

FIG. 1 is a block diagram of a system in accordance with the present invention;

FIG. 2 is a flow chart that illustrates entry by a user into the system of FIG. 1;

FIG. 3 is a flow chart depicting activities resulting from a choice to enter the secondary distribution site of the system of FIG. 1;

FIG. 4 is a flow chart illustrating the process that takes place when a user elects to view the auction site of the system of FIG. 1; and

FIG. 5 is a flow chart that depicts the lottery distribution elements of the system of FIG. 1.

### DETAILED DESCRIPTION OF THE INVENTION

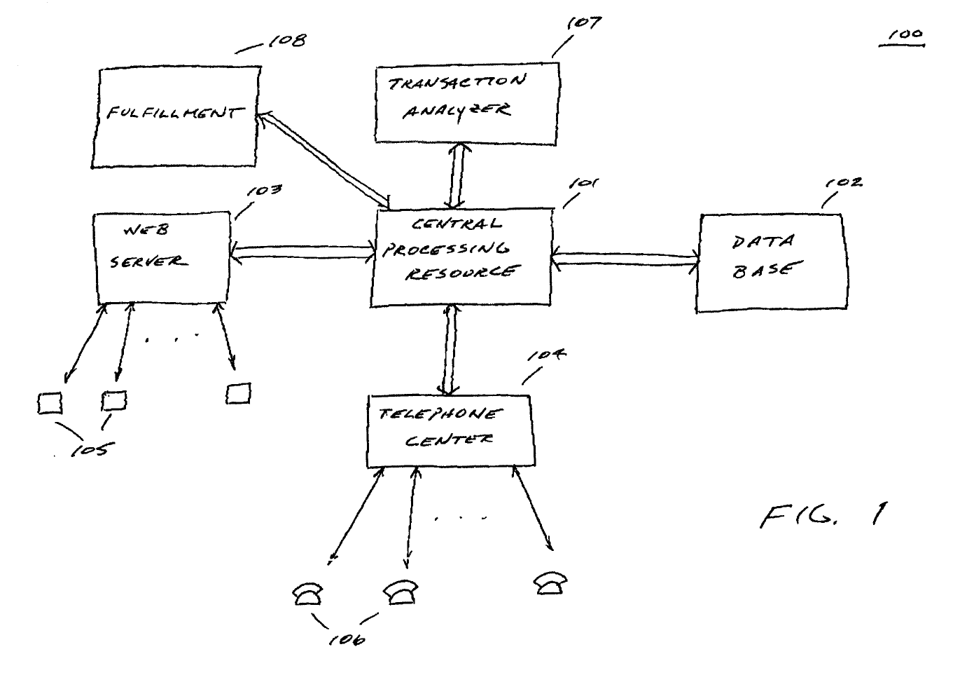

There is described herein an event ticket pricing and distribution system that offers distinct advantages when compared to distribution methodologies of the prior art. FIG. 1 depicts a block diagram of a distribution system in accordance with the present invention, generally depicted by the numeral 100.

A central processing resource 101 is provided to manage data interchange among system components. Of course, as will be appreciated by those skilled in the art, there are many potential implementations of system architectures that satisfy the hardware requirements of the system described herein, and the block diagram depiction of FIG. 1 is intended to suggest the arrangement of system components in such a way as to foster understanding of system operation, rather than to provide a detailed hardware specification.

The central processor 101 may be comprised of one or more file servers and application servers, for example, adequately isolated from adjacent system components by firewalls where necessary. The data base 102 coupled to the central processor 101 may similarly be constructed of one or more high-capacity disk storage systems, one or more associated file servers, a data base application server, and appropriate firewall systems. The central processing resource 101 is preferably coupled to a web server 103 to allow prospective purchasers to access the system 100 over the Internet via their own terminals 105.

However, it is also intended that ticket purchasers who wish to use the system should not be precluded from doing so simply because they lack computer resources. Consequently, a telephone center 104 may also be coupled to the central processor 101 to facilitate phone-in use, as will be discussed in greater detail below.

The system 100 is also coupled to a fulfillment system 108, that is capable of printing and delivering tickets to a designated purchaser. In order to accomplish this, relevant data is transferred from the central processor 101 to the fulfillment system 108. Fulfillment may be accomplished by the system proprietor, or it may be outsourced to an established fulfillment enterprise.

The system 100 also makes use of a transaction analyzer 107, which, from a system architecture standpoint, may be integrated into the central processing resource 101, but is illustrated as a separate component for the sake of clarity of explanation. As will be discussed in more detail in a subsequent section, the transaction analyzer 107 monitors transactions that occur on the system 100 for purposes of statistical analysis and evaluation. The results of this analysis are used in controlling system operation. Statistical analysis of both Internet and telephone oriented transactions is well-known in the art, so the specifics of statistical analysis engines are not re-introduced here for the sake of brevity.

Since the inventive system employs both an auction distribution and a secondary distribution of event tickets, initial pool allocations are determined prior to system start-up for a particular event. A portion of the tickets is allocated to a first distribution pool (for the auction), while the remaining tickets are allocated to at least one other distribution pool.

The prices of the tickets in secondary distribution must also be decided. Preferably, this is a standard/fixed price, but those who receive tickets as a result of the secondary distributions may in fact win any category of ticket, as some of the best tickets may also be made available for secondary distribution. Some of the other details to be decided up front include the starting price for the auction distribution, the charities that may benefit from subscription fees for secondary distribution participants, and overall system timing, For example, when the auction begins and ends, when price changes take place for the auction, and when secondary distributions begin.

These pre-process decisions may develop into something of a balancing act amenable to a scientific disposition. Ultimately, the seller's primary concern is to maximize revenues through ticket sales and site visits. Ignoring revenues from site visits (to be discussed in more detail subsequently), the seller's key concern is to reach a relatively accurate assessment of expected ticket revenue, and to use the variables available in order to maximize this figure while minimizing potential downside if anticipated demand is not present.

Key variables are thus the ticket price to be paid in secondary distribution, and the relative proportions of tickets distributed by the auction and by secondary distribution methods. There are, of course, numerous potential strategies. The transaction analyzer 107 (FIG. 1) progressively accumulates data on events sold using the inventive system. Using this accumulated data, and also applying mathematical techniques (statistical analysis) over time, the transaction analyzer provides to the Seller a range of strategies for reaching optimal income levels with different levels of risk. The transaction analyzer 107 will also give accurate estimates of income ranges under various strategies.

Examples of the types of data the transaction analyzer offer are given below:

1. Estimated Gross Ticket Revenues based on combinations of the above variables.

2. Ranges and probabilities associated with those revenue estimates (e.g., estimated GTR $1.3 M, 75% likely to be between $1.2 M and $1.35 M, 85% likely to be between $1.18 M and $1.37 M, 98% certain that base revenue will exceed $1.177M).

3. The effect of small adjustments of the variables in terms of estimates, ranges and probabilities (e.g., increasing the price to secondary distributees by 5%, and reducing the proportion distributed by auction by 10%, will increase the 98% likely base revenue to $1.26M, but reduce the estimated revenue to $1.29M and a narrower range).

Other factors may also be applied to the variables, such as the effect of tiering in the prices and of offering discounts per ticket if more than a certain amount are won (win a single ticket pay $25, apply for 4 tickets, and, if you win, it only costs $90).

The statistical analyzer will also preferably factor in strategies to maximize site interest and visits (which would certainly be influenced by adjusting the key variables) if that is a major income driver for a particular event. As is common in statistical analysis, this model becomes more and more accurate (narrower ranges, greater accuracy and certainty) as more and more data are gathered.

The distribution of event tickets via auction distribution preferably begins by quoting a very high (too high) price. This is important to ensure that the highest edge of demand is met and can be publicly justified as such. It is also helpful to the seller that a very high price can be offered without ridicule, and it is a feature of “Dutch Auctions” (price reduction auctions that this may result in bids being attracted at higher levels than would otherwise occur for the benefit of certainty and reflecting a lack of price sensitivity.

As mentioned briefly above (and to be treated hereinbelow with greater specificity), the charities that may benefit from subscription fees charged to participants in secondary distribution may be chosen at the discretion of the seller, performer, a grouping of charities appointed in any other way, or may even be a listing of approved charities that may be nominated by each individual customer when subscribing to the secondary distribution. This subscription fee may be nominal since it does not benefit the seller, only the designated charity. Its primary function is the discouragement of systematic manipulation of the lottery process by professional brokers and touts.

As noted above, the transaction analyzer 107 provides data, projections and probabilities to enable accurate estimation and maximization of ticketing income through use of the key “pre-process” variables. It is a tool to enable the seller to make the best pre-process decisions. As noted, it will become more accurate and more reliable the more it is used. Ultimately, this has the potential to be a source of sustainable competitive advantage.

The transaction analyzer 107 also provides useful information during the operation of the process. The assimilation of data on the registrations for secondary distribution (who are registering, how fast. they are registering, how often, what numbers of tickets each are

applying for, etc.,) will potentially change or confirm the original estimates. Similarly, data on the operation of the auction distribution (who is registering and viewing the auction compared to other similar events, time spent on the site, whether they have also registered for the secondary distributions, etc.) will be examined for correlations.

The updated information and estimates allow the seller to manipulate the process in order to optimize the result. It will, for example, influence the pricing decisions on each re-pricing of the auction or potentially an increase/decrease in the price to be paid by secondary distributees.

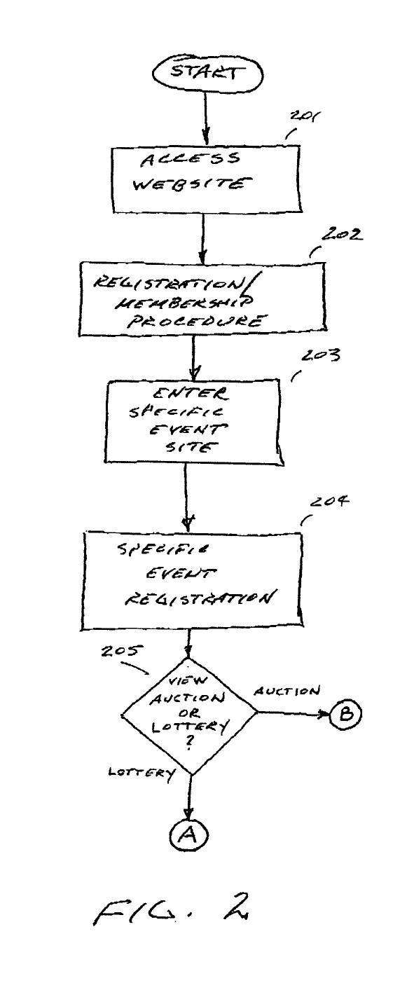

FIG. 2 is a flow chart that illustrates entry into the is system by a user. In step 201, the user accesses the system website. This site could be a ticket distributor's site, a promoter's site, etc. It may also be a marketplace site for all suitable event ticket sales world-wide. The site lists the various events being sold on the site and categorises them (e.g. by location, date, event type, etc.), and also gives an indication of the status of the events-i.e. when auction/secondary distribution are to start/expire

Preferably, the site gives information on the process and why it is beneficial to all parties (general public, public policy, governmental agencies, etc.). It will give information about the basis for the transparent secondary distribution scheme and the workings of the auction distribution. It will allow event organizers to apply to use the site for selling their events, and/or link to giving them further information about how it would work from their point of view. In addition, the site offers the option of Membership/General Registration, and the opportunity to enter specific event sites. it provides links to further information on related topics, and it hosts relevant advertising and sales links.

A registration/membership option process is next conducted. This is an option that allows customers the opportunity to generally register for all events offered on the site: it means that there are no requirements for individual registration for events, so that participants can proceed directly into the auction/secondary distribution process without any further delays or additional requirements. The site also offers the possibility of special offers, membership benefits, pre-notification of coming events and relater products, links with other clubs, and selected retailers/e-tailers/service providers

Registration may provide a membership password/number with normal security issues addressed (much like accessing one's web mail site, or the transaction site of a financial institution or bank). When a member enters the web-site, he is asked for his password/security information, and then allowed to go to any part of the site directly. He is also allowed to bid in the auction, or subscribe for secondary distribution with no further registration requirements.

The information given at registration preferably includes name, postal address, and e-mail address. It should also allow for the taking of payment details on a secure basis (well-known in the art) in order to facilitate the most efficient participation in the auction, secondary distribution, and related sales links. It should also allow (perhaps optional for customers) submission of other relevant database material (date of birth, event/product preferences etc.).

Participation in the secondary distribution may require submission of payment details in advance so that payment is pre-cleared for all winners and the charitable donation is made from the subscription fee paid at entry. Participation in the auction does not strictly require credit/debit card/payment details in advance of a bid, however. Pre-clearance of funds is unlikely (though still possible, of course) because the size of the potential bid is unknown. However, to enable maximum prioritization of the bid, the customer should at least submit credit card details (again, securely) so that these details do not have to be input at the time of the bid, and can be sent directly for authorization, enabling fastest prioritization.

Next (step 203), the user enters the site for the particular event being sold. It is envisioned that each event will have its own site. This allows more targeted advertising and links. This arrangement also allows the user to view everything in connection with the event, but requires a membership password or registration number in order for participation in the auction or secondary distributions to be authorized (and possibly to view much of the related information). It will be possible to track who is entering which event site and how long they are staying, and whether they are checking the auction price etc., as each party will need to quote a registration/membership number in order to progress, Next (step 204), the user engages in specific event registration. This is an absolute requirement if the user is not a general member in order to participate in the auction/secondary distribution (and potentially to get full access to the specific event site). It is important for the transaction analyzer (107 in FIG. 1) to track traffic on a specific basis, as well as to enable the auction and secondary distributions to progress efficiently. Complete registration also enables the customer to be e-mailed (either as a requested function or automatic function for members or for any registered party) when the auction price changes, with a link back to the event site to check it.

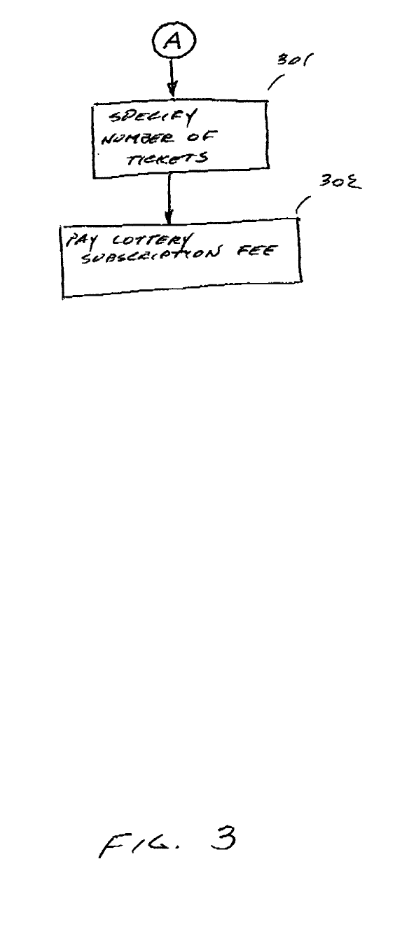

The user is then prompted (step 205) to select Auction View, or to proceed to registration for the secondary distribution. FIG. 3 is a flow chart depicting activities resulting from a choice to enter the secondary distribution site. In the preferred embodiment, one of the secondary distributions is a lottery distribution. Of course, once registered, or as a general member, the customer can choose to enter the auction, the secondary distribution (lottery) or both.

In step 301, the user can specify that he wishes to purchase any number of tickets (may be limited, as some known distribution sites generally limit to 8 tickets per application). If a given user happens to win in the lottery distribution, the winner will get that number of tickets, as close to one another as possible (preferably adjacent). A winner will only win that number of tickets, not more or less.

A feature of the present system is that, if a user should apply for 5 tickets, the chances of winning are smaller than if he had applied for the minimum number of tickets. There are many ways of reducing odds of winning based upon number of tickets requested, but, no matter which method is selected, a proportionate relationship should be maintained. It is also possible that the pricing decision process outlined above may involve discounts on the ticket price if the user happens to win more than a certain number of tickets.

In any event, this lottery form of the secondary distribution is highly transparent, and the system operator may indeed wish to provide transaction data as objective evidence of the inherent fairness of the process. Users may preferably enter as many times as they like subject to paying the nominal subscription fee, but will not have to pay more than once. For example, if a lottery participant were to enter twelve times, requesting 4 tickets each time, he would have to pay the nominal subscription fee for each entry, and the multiple entries will enhance his chances of winning. However, the system is designed so that each registrant can win no more than once, so he would only pay for 4 tickets if he were a lottery winner.

There are, of course, considerable promotional opportunities associated with the process, for example, the highest auction bidder and the first lottery winner may he awarded similar “VIP” packages (transportation to the event, etc.).

In the subsequent step (302), the lottery subscription price may be paid to charity, or elsewhere. The rationale is that this process is ultimately fairer and better for the consumer. Rather than having to queue at particular locations or try to beat the touts on the telephone/Internet queues, customers have a fair and transparent process for obtaining tickets at reasonable prices. The promoter may not benefit from this element, the subscription fees may go instead to charity, or elsewhere, as determined. The subscription price for the lottery distribution will preferably be nominal (e g., $1) but it is important to note that the chances of winning are very high, (unlike a state lottery for example). As mentioned previously, the primary purpose of the subscription fee is not promoter profit, but distribution system equity.

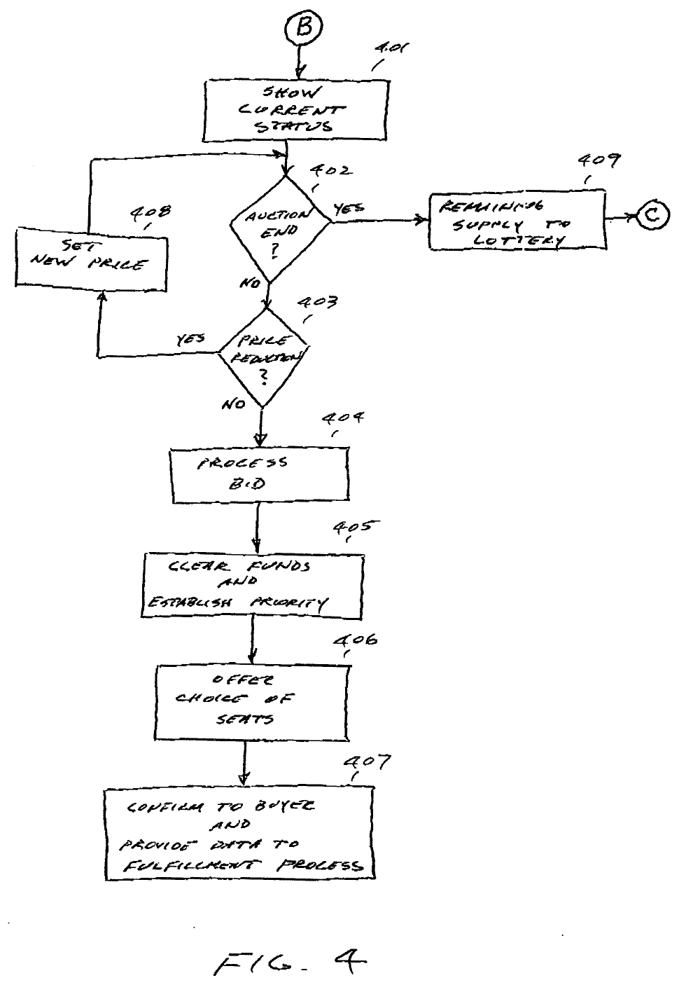

FIG. 4 is a flow chart illustrating the process that takes place if the user elects to view the auction site. In step 401, key elements of the auction are displayed. These elements preferably include the current price being offered (or when the first price will be offered, if the auction has not yet begun). The time of expiration of the current offer (the time of the next price reduction) will also be displayed, unless the supply has been exhausted before that. The auction site will also indicate the seats that remain available to be purchased by auction. This is intended to allow purchasers to know what they are bidding for. However, these details are preferably vague enough to give minimum information to potential purchasers about demand/how many seats are unsold, etc.

The test for auction termination occurs in step 402. The auction will terminate before the lottery (secondary distribution) regardless of whether all of the tickets allocated to the auction by way of the first distribution pool are sold. The auction price can never be it the level of the lottery price, so any unbid tickets will be allocated to the lottery at auction termination (step 409). The transaction analyzer (107 in FIG. 1) aims to optimize this process and ensure that the best decisions are made before and during the process. The lottery takes place after the auction in order that no one will be sure of getting tickets unless they bid at the auction. This is vitally important to optimize the auction results.

If the time for a price reduction has not arrived (evaluated in step 403), participant bids are processed. A user preferably bids by clicking on the appropriate button and possibly re-confirming a password. As the auction should ensure that there is never heavy bidding (by pitching at the very edge of demand), there should never be a rush. However, as each price will be offered for a defined period, and each successful bidder has his choice of tickets, there must be a prioritization system.

For the sake of efficient operation, a bidder can pre-clear any amount at registration to ensure maximum system throughput with respect to his bid. He will also be able to submit credit card details in step 405 for immediate clearance at time of bidding. Alternatively, the user may choose to give his credit card number at the time of bidding, but this is clearly the slowest choice in terms of prioritization, and the bidder risks being passed by other cleared bidders, or even risks a sell out during the processing interval.

There is excellent technology available for giving a bidder the view of the seats available, and even of the view from those seats in three-dimensional perspective. In step 406, the successful bidder is offered his choice of seats, preferably in conjunction with this technology. The bidder knows within minutes (similar to the speed of credit card machines in retail businesses) whether he is successful, and it is confirmed by e-mail (step 407). In the alternative, of course, the bidder may be alerted through messaging to his mobile telephone, or by direct telephone contact in the case of those who are telephoneonly participants. The fulfilment process (the actual provision of tickets to the winner) can be carried out as part of this process, or outsourced with the relevant data being passed to the fulfilment source. Preferably, the winning bidder may choose fulfilment options (e.g., post, courier, collect at venue, etc.) with defaults having been specified at registration time.

If the time for price reduction has arrived, as determined in step 403 above, the next process step (408) sets the new auction price. At pre-determined intervals, the seller adjusts downward the price of the ticket for the auction until the supply is exhausted, or until the auction closing date. The transaction analyzer 107 of FIG. 1 uses the pre-process decisions and accumulated data on registrations, site usage, etc., to aid this process. At auction termination, unsold tickets in the first distribution pool (the auction pool) are transferred to the second distribution pool (the lottery pool) in Step 409.

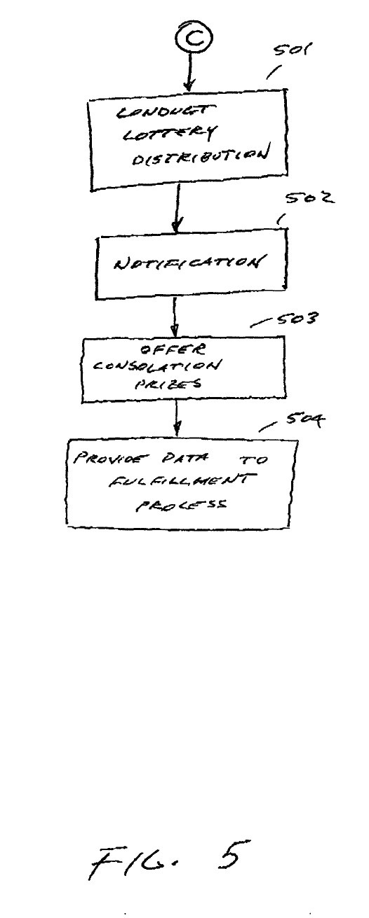

FIG. 5 is a flow chart that depicts the lottery distribution elements. The lottery itself (step 501) takes place on a predetermined date after the end of the auction. It is highly transparent and the procedures are open to objective inspection. As discussed above, winners are selected at random, but the lottery is preferably weighted such that chances of winning decrease with an increasing number of tickets selected by a given participant. Other weighting criteria may also be used, such as geographic location, club/association membership, or even the participation history of the participant. For example, the promoter may decide to enhance the chances of winning for a participant who has not been successful in the lottery distribution in the past.

In the subsequent step 502, the winners are notified at the e-mail address specified at registration, and pre-cleared payment is deducted from the credit/debit card. Losers in the lottery distribution may also be e-mailed for notification. In step 503, a proportion of people who do not win the lottery are offered consolation prizes. This is an opportunity for promotion by the event organizer or various other retailers or service providers. Data are provided to the fulfillment process (step 504) in much the same way described above for the auction distribution.

It is important to note that the system is described in conjunction with FIG. 1 above is not solely an Internet model. It is possible easily to accommodate telephone use for both the lottery and auction. In fact, the method has the added benefit of eliminating the need to beat the telephone queue as the timing rush issue is eliminated. Customers could register by telephone, or, of course, at ticket booths, could quote registration/membership number to participate in the auction and lottery by telephone, and could receive all relevant information as to next price reduction and tickets available over a telephone hook-up.

It should also be noted that the system 100 of FIG. 1 incorporates a stored-program computer as a component of the central processing resource 101, and that this central processing resource includes a memory (not illustrated in the figure) for storing the computer program or programs that operate the system. The central processor 101 is operative, in conjunction with the memory, to perform the steps outlined above with reference to FIGS. 2 through 5.

There has been described herein an event ticket pricing and distribution system that offers distinct advantages when compared with the prior art. It will be apparent to those skilled in the art that modifications may be made without departing from the spirit and scope of the invention. Accordingly, it is not intended that the invention be limited except as may be necessary in view of the appended claims.

What is claimed is:

1. A method for event ticket distribution, the method comprising the steps of:
(a) distributing event tickets allocated to a first distribution pool in accordance with a decreasing selling price auction distribution, and, upon completion of said auction distribution;
(b) distributing event tickets allocated to at least a second distribution pool.

2. The method in accordance with claim 1, wherein the step (a) of distributing event tickets in accordance with a decreasing selling price auction distribution further includes the steps of:
(a1) determining an initial size for the first distribution pool;
(a2) establishing an initial selling price for the event tickets in the first distribution pool; and
(a3) determining a price decrement amount for the decreasing selling price auction.

3. The method in accordance with claim 1, wherein the step (a) of distributing event tickets in accordance with a decreasing selling price auction distribution further includes, during the auction distribution, the steps of:
(a4) collecting and recording transaction information related to said decreasing selling price auction distribution;
(a5) dynamically determining selling price decrement amount based, at least in part, upon said transaction information; and
(a6)dynamically determining relative sizes of said at least first and second distribution pools based, at least in part, upon said transaction information.

4. The method in accordance with claim 3, further comprising:
dynamically determining a termination time for the step (a) of distributing event tickets in accordance with a decreasing selling price auction distributior based, at least in part, upon said transaction information.

5. The method in accordance with claim 1, wherein the step (b) of distributing event tickets allocated to at least a second distribution pool comprises distributing said event tickets in accordance with a lottery distribution.

6. The method in accordance with claim 5, wherein the step (b) of distributing said event tickets in accordance with a lottery distribution further comprises the steps of.
(b1) collecting and recording lottery participant information;
(b2) collecting and recording ticket request information, including number of tickets requested by each lottery participant; and
(b3) identifying participants to whom tickets are distributed.

7. The method in accordance with claim 6, wherein the step of identifying participants to whom tickets are distributed includes a random selection process weighted in accordance with predetermined weighting criteria.

8. The method in accordance with claim 7, wherein the predetermined weighting criteria include geographic location of the participant.

9. The method in accordance with claim 7, wherein the predetermined weighting criteria include association membership of the participant.

10. The method in accordance with claim 7, wherein the predetermined weighting criteria include participation history of the participant.

11. The method in accordance with claim 7, wherein the selection process is weighted such that probability of selection for a participant decreases with increasing number of tickets selected by said participant.

12. The method in accordance with claim 6, wherein the step of collecting and recording lottery participant information includes the step of charging each lottery participant a predetermined subscription fee.

13. The method in accordance with claim 4, wherein event tickets remaining in the first distribution pool are reallocated to the second distribution pool at said termination time.

14. A method for event ticket distribution, the method comprising the steps of:
(a) allocating event tickets to at least first and second distribution pools;
(b) collecting and recording participant information;
(c) distributing event tickets allocated to said first distribution pool in accordance with a decreasing selling price auction distribution, and, during said distribution:
(i) collecting and recording transaction information related to said decreasing selling price auction distribution;
(ii) dynamically determining selling price decrement amount based, at least in part upon said transaction information;
(iii) dynamically determining relative sizes of said at least first and second distribution pools based, at least in part, upon said transaction information; and, upon completion of said decreasing selling price auction distribution;
(d) distributing event tickets allocated to at least said second distribution pool.

15. The method in accordance with claim 14, further comprising:
dynamically determining a termination time for the step (a) of distributing event tickets in accordance with a decreasing selling price auction distribution based, at least in part, upon said transaction information.

16. The method in accordance with claim 14, wherein the step (d) of distributing event tickets allocated to at least a second distribution pool comprises distributing said event tickets in accordance with a lottery distribution.

17. The method in accordance with claim 16, wherein the step (d) of distributing said event tickets in accordance with a lottery distribution further comprises the steps of:
(d1) collecting and recording lottery participant information;
(d2) collecting and recording ticket request information, including number of tickets requested by each lottery participant; and
(d3) identifying participants to whom tickets are distributed.

18. The method in accordance with claim 17, wherein the step of identifying participants to whom tickets are distributed includes a random selection process weighted in accordance with predetermined weighting criteria.

19. The method in accordance with claim 18, wherein the predetermined weighting criteria include geographic location of the participant.

20. The method in accordance with claim 18, wherein the predetermined weighting criteria include association membership of the participant.

21. The method in accordance with claim 18, wherein the predetermined weighting criteria include participation history of the participant.

22. The method in accordance with claim 18, wherein the selection process is weighted such that probability of selection for a participant decreases with increasing number of tickets selected by said participant.

23. The method in accordance with claim 17, wherein the step of collecting and recording lottery participant information includes the step of charging each lottery participant a predetermined subscription fee.

24. The method in accordance with claim 15, wherein event tickets remaining in the first distribution pool are reallocated to the second distribution pool at said termination time.

25. A method for event ticket pricing and distribution, the method comprising the steps of:
(a) allocating event tickets to at least first and second distribution pools;
(b) collecting and recording participant information;
(c) distributing event tickets allocated to said first distribution pool in accordance with a decreasing selling price auction distribution, and, during said distribution:
(i) collecting and recording transaction information related to said decreasing selling price auction distribution;
(ii) dynamically determining selling price decrement amount based, at least in part, upon said transaction information;
(iii)dynamically determining relative sizes of said at least first and second distribution pools based, at least in part, upon said transaction information;
(iv) dynamically determining a termination time for the step (c) of distributing event tickets in accordance with a decreasing selling price auction distribution based, at least in part, upon said transaction information; and, at a predetermined time;
(d) distributing event tickets allocated to at least said second distribution pool in accordance with a lottery distribution that includes the steps of:
(v) collecting and recording lottery participant information;
(vi) collecting and recording ticket request information, including number of tickets requested by each lottery participant; and
(vii)identifying participants to whom tickets are distributed.

26. The method in accordance with claim 25, wherein the step (vii) of identifying participants to whom tickets are distributed includes a random selection process weighted in accordance with predetermined weighting criteria.

27. The method in accordance with claim 26, wherein the predetermined weighting criteria include geographic location of the participant.

28. The method in accordance with claim 26, wherein the predetermined weighting criteria include association membership of the participant.

29. The method in accordance with claim 26, wherein the predetermined weighting criteria include participation history of the participant.

30. The method in accordance with claim 26, wherein the selection process is weighted such that probability of selection for a participant decreases with increasing number of tickets selected by said participant.

31. The method in accordance with claim 25, wherein the step (v) of collecting and recording lottery participant information includes the step of charging each lottery participant a predetermined subscription fee.

32. The method in accordance with claim 25, wherein event tickets remaining in the first distribution pool are reallocated to the second distribution pool at said termination time.

33. A system for event ticket distribution comprising:
means for distributing event tickets allocated to a first distribution pool in accordance with a decreasing selling price auction distribution; and
means for distributing event tickets allocated to at least a second distribution pool upon completion of said auction distribution;

34. The system of claim 33, wherein the means for distributing event tickets in accordance with a decreasing selling price auction distribution further comprises:
means for determining an initial size for the first distribution pool;
means for establishing an initial selling price for the event tickets in the first distribution pool; and
means for determining a price decrement amount for the decreasing selling price auction.

35. The system of claim 33, wherein the means for distributing event tickets in accordance with a decreasing selling price auction distribution further comprises:
means for collecting and recording transaction information related to said decreasing selling price auction distribution, during said distribution;
means for dynamically determining selling price decrement amount based, at least in part, upon said transaction information; and
means for dynamically determining relative sizes of said at least first and second distribution pools based, at least in part, upon said transaction information.

36. The system of claim 35, further comprising:
means for dynamically determining a termination time for the decreasing selling price auction distribution based, at least in part, upon said transaction information.

37. The system of claim 33, wherein the means for distributing event tickets allocated to at least a second distribution pool comprises means for distributing said event tickets in accordance with a lottery distribution.

38. The system of claim 37, wherein the means for distributing said event tickets in accordance with a lottery distribution further comprises;
means for collecting and recording lottery participant information;
means for collecting and recording ticket request information, including number of tickets requested by each lottery participant; and
means for identifying participants to whom tickets are distributed.

39. The system of claim 38, wherein the means for identifying participants to whom tickets are distributed comprises a random selection process weighted in accordance with predetermined weighting criteria.

40. The system of claim 39, wherein the predetermined weighting criteria include geographic location of the participant.

41. The system of claim 39, wherein the predetermined weighting criteria include association membership of the participant.

42. The system of claim 39, wherein the predetermined weighting criteria include participation history of the participant.

43. The system of claim 39, wherein the selection process is weighted such that probability of selection for a participant decreases with increasing number of tickets selected by said participant.

44. The system of claim 38, wherein the means for collecting and recording lottery participant information includes means for charging each lottery participant a predetermined subscription fee.

45. The system of claim 36, wherein event tickets remaining in the first distribution pool are reallocated to the second distribution pool at said termination time.

46. A system for event ticket distribution comprising:
means for allocating event tickets to at least first and second distribution pools;
means for collecting and recording participant information;
means for distributing event tickets allocated to said first distribution pool in accordance with a decreasing selling price auction distribution;
means for collecting and recording transaction information related to said decreasing selling price auction distribution, during said distribution;
means for dynamically determining selling price decrement amount based, at least in part, upon said transaction information;
means for dynamically determining relative sizes of said at least first and second distribution pools based, at least in part, upon said transaction information; and,
means for distributing event tickets allocated to at least said second distribution pool upon completion of said auction distribution.

47. The system of claim 46, further comprising:
means for dynamically determining a termination time for the decreasing selling price auction distribution based, at least in part, upon said transaction information.

48. The system of claim 46, wherein the means for distributing event tickets allocated to at least a second distribution pool comprises means for distributing said event tickets in accordance with a lottery distribution.

49. The system of claim 48, wherein the means for distributing said event tickets in accordance with a lottery distribution further comprises:
means for collecting and recording lottery participant information;
means for collecting and recording ticket request information, including number of tickets requested by each lottery participant; and
means for identifying participants to whom tickets are distributed.

50. The system of claim 49, wherein the means for identifying participants to whom tickets are distributed comprises a random selection process weighted in accordance with predetermined weighting criteria.

51. The system of claim 50, wherein the predetermined weighting criteria include geographic location of the participant.

52. The system of claim 50, wherein the predetermined weighting criteria include association membership of the participant.

53. The system of claim 50, wherein the predetermined weighting criteria include participation history of the participant.

54. The system of claim 50, wherein the selection process is weighted such that probability of selection for a participant decreases with increasing number of tickets selected by said participant.

55. The system of claim 49, wherein then means for collecting and recording lottery participant information includes means for charging each lottery participant a predetermined subscription fee.

56. The system of claim 47, wherein event tickets remaining in the first distribution pool are reallocated to the second distribution pool at said termination time.

57. A system for event ticket pricing and distribution comprising:
means for allocating event tickets to at least first and second distribution pools;
means for collecting and recording participant information;
means for distributing event tickets allocated to said first distribution pool in accordance with a decreasing selling price auction distribution;
means for collecting and recording transaction information related to said decreasing selling price auction distribution during said distribution;
means for dynamically determining selling price decrement amount based, at least in part, upon said transaction information;
means for dynamically determining relative sizes of said at least first and second distribution pools based, at least in part, upon said transaction information;
means for dynamically determining a termination time for the decreasing selling price auction distribution based, at least in part, upon said transaction information;
means for distributing event tickets allocated to at least said second distribution pool in accordance with a lottery distribution at a predetermined time;
means for collecting and recording lottery participant information;
means for collecting and recording ticket request information, including number of tickets requested by each lottery participant; and
means for identifying participants to whom tickets are distributed.

58. The system of claim 57, wherein the means for identifying participants to whom tickets are distributed comprises a random selection process weighted in accordance with predetermined weighting criteria.

59. The system of claim 58, wherein the predetermined weighting criteria include geographic location of the participant.

60. The system of claim 58, wherein the predetermined weighting criteria include association membership of the participant.

61. The system of claim 58, wherein the predetermined weighting criteria include participation history of the participant.

62. The system of claim 58, wherein the selection process is weighted such that probability of selection for a participant decreases with increasing number of tickets selected by said participant.

63. The system of claim 57, wherein thus means for collecting and recording lottery participant information includes means for charging each lottery participant a predetermined subscription fee.

64. The system of claim 57, wherein event tickets remaining in the first distribution pool are reallocated to the second distribution pool at said termination time.

65. A system for event ticket distribution comprising:
a memory device storing a program;
a processor in communication with the memory, the processor operative with said program to:
allocate event tickets to at least first and second distribution pools;
collect and record participant information,
distribute event tickets allocated to said first distribution pool in accordance with a decreasing selling price auction distribution;
collect and record transaction information related to said decreasing selling price auction distribution, during said distribution,
dynamically determine selling price decrement amount based, at least in part, upon said transaction information;
dynamically determine relative sizes of said at least first and second distribution pools based, at least in part, upon said transaction information; and,
distribute event tickets allocated to at least said second distribution pool upon completion of said auction distribution.

66. The system of claim 65, wherein the processor is operative to dynamically determine a termination time for the decreasing selling price auction distribution based, at least in part, upon said transaction information.

67. The system of claim 65, wherein the processor is operative to distribute event tickets allocated to said at least a second distribution pool in accordance with a lottery distribution.

68. The system of claim 67, wherein the processor is further operative to:
collect and record lottery participant information;
collect and record ticket request information, including number of tickets requested by each lottery participant; and
identify participants to whom tickets are distributed.

69. The system of claim 68, wherein the processor is operative to identify participants to whom tickets are distributed using a random selection process weighted in accordance with predetermined weighting criteria.

70. The system of claim 69, wherein the predetermined weighting criteria include geographic location of the participant.

71. The system of claim 69, wherein the predetermined weighting criteria include association membership of the participant.

72. The system of claim 69, wherein the predetermined weighting criteria include participation history of the participant.

73. The system of claim 69, wherein the selection process is weighted such that probability of selection for a participant decreases with increasing number of tickets selected by said participant.

74. The system of claim 68, wherein the processor is operative to charge each lottery participant a predetermined subscription fee.

75. The system of claim 66, wherein the processor is operative to reallocate event tickets remaining in the first distribution pool to the second distribution pool at said termination time.
